(19) United States
(12) Patent Application Publication
(10) Pub. No.: US 2022/0318725 A1
(43) Pub. Date: Oct. 6, 2022

(54) GOODS CARRIER

(71) Applicant: Bayer Business Services GMBH, Köln (DE)

(72) Inventors: Jürgen HOHMANN, Odenthal (DE); Robert WOLLENHAUPT, Langenfeld (DE); Frank DIETZ, Bergisch Gladbach (DE); Josephine BRAVIDOR, Berlin (DE)

(73) Assignee: Bayer Business Services GMBH, Köln (DE)

(21) Appl. No.: 17/595,926

(22) PCT Filed: May 18, 2020
(86) PCT No.: PCT/EP2020/063751

§ 371 Date: Nov. 29, 2021

(30) Foreign Application Priority Data
May 27, 2019 (EP) 19176794.6

(51) Int. Cl. G06Q 10/08

(52) U.S. Cl. CPC G06Q 10/087

(57) ABSTRACT

A goods carrier for the presentation of product units comprises a goods holder device for holding a plurality of product units, a control unit, a data store, and a position sensor, wherein the position sensor is configured to record measured values relating to a position of the goods carrier, and wherein the control unit is configured to receive the measured values from the position sensor and store them in the data store. A goods carrier may also include an acceleration sensor, a magnetometer, an inventory sensor, or a timer. A method for monitoring a goods carrier may include recording an inventory of product units in the goods carrier, determining a time interval during which there are no product units present in the goods carrier, and displaying the time interval to a person.

### CROSS REFERENCE TO RELATED APPLICATIONS

This application is a national stage application under 35 U.S.C. § 371 of International Application No. PCT/EP2020/063751, filed internationally on May 18, 2020, which claims benefit of European Application No. 19176794.6, filed May 27, 2019.

### FIELD OF THE INVENTION

The present disclosure relates to the technical field of goods placement and goods presentation. The present disclosure relates to a monitoring unit which can be connected to a goods carrier, a goods carrier, a system comprising a monitoring unit and a goods carrier, and a method for monitoring a goods carrier.

### BACKGROUND OF THE INVENTION

Today, customers' purchasing decisions are significantly influenced by where and how the goods are presented. The placement of goods and the presentation of goods are among the most important activities for sales promotion. Their aim is to encourage the customer to make purchases, to stimulate their demand for the goods on display, and to provide them with a positive shopping experience.

Questions associated with the placement and presentation of goods relate to the position, the extent, and the form in which groups of goods and individual products are placed on the sales floor and on the shelves.

In particular, a manufacturer of new, as yet unknown products may be interested in the products being placed in such a way that they are visible to as many customers as possible. The manufacturer often produces special goods carriers, in particular for new products, which are intended to attract the attention of the customers and designed to introduce and promote the as yet unknown product.

The analysis of the sales data can provide the manufacturer with important information about how the presentation of the (new) products is received by the customers. The manufacturer can use sales data to analyze what type of goods presentation and what type of goods placement are particularly successful.

One problem with this, however, is that the interests of manufacturers and vendors do not always coincide. It may be the case that a manufacturer has designed a special product carrier for a new product to present and promote the product. The manufacturer has an interest in placing the goods carrier in a prominent position on the sales floor and asks the vendor for an appropriate placement or places the goods carrier there themselves. It is conceivable that the vendor will place the goods carrier elsewhere after a short time, because they would like to use the prominent position for some other purpose. The manufacturer will not usually be informed about the re-positioned goods carrier and the recorded sales data can no longer be correlated with the original location of the goods carrier.

Another problem may be that an empty goods carrier is not replenished by the seller in a timely manner, so that the number of sales is limited by the fact that there are not enough product units in the goods carrier. In such a case, the sales data also no longer correlate with the desired goods presentation and goods placement.

The present disclosure is dedicated to these problems.

### SUMMARY OF THE INVENTION

The present disclosure relates to a goods carrier for the presentation of product units, comprising
a goods holder device for holding a plurality of product units,
a control unit,
a data store, and
a position sensor,
   wherein the position sensor is configured to record measured values relating to a position of the goods carrier, and wherein the control unit is configured to receive the measured values from the position sensor and store them in the data store.

The goods carrier according to the present disclosure is used for product presentation. The term “presentation” preferably includes the terms “presenting” and “displaying”, i.e. a product is preferably both presented in terms of content and displayed as an item (offered for sale).

The product may be any item (a physical product) that can be offered and sold commercially.

Preferred products are medicines, food supplements, cosmetics, perfumes, cleaning agents, plant care products, and/or similar items.

Products are usually offered for purchase in a showroom of a store. The store is preferably a pharmacy.

The product is usually offered in the form of product units. A product unit comprises a defined quantity of the product, usually packed in a package or in a plurality of packages.

A package can be used to put the product in a transportable condition and/or to protect it from environmental influences that might damage the product (e.g. moisture, oxygen, light, and the like).

Examples of packages are cartons (cardboard boxes), boxes, blister packs, canisters, bottles, bags, sachets, containers, and the like.

For example, with regard to a medicine in tablet form, a product unit may comprise one or more blister strips in which the tablets are individually encapsulated. Usually, multiple blister strips are inserted in a small cardboard box together with a package insert. In such a case, the goods carrier is designed in such a way that it can hold a plurality of these cardboard boxes.

### DETAILED DESCRIPTION OF THE INVENTION

As described above, the present disclosure relates to a monitoring unit which can be connected to a goods carrier, a goods carrier, a system comprising a monitoring unit and a goods carrier, and a method for monitoring a goods carrier.

To accommodate a plurality of product units, the goods carrier may have a goods holder on which several product units can be placed. Such a goods holder can be a container or a storage tray or a shelf, a drawer, or a compartment or the like.

Preferably, the goods holder is designed in such a way that the product units can be removed individually. The product units can be stored in the goods holder, for example, on top of one another as stacks and/or next to one another.

In some embodiments, a goods carrier may comprise a plurality of goods holders.

The goods carrier may comprise a control unit for controlling the electrical/electronic components of the goods carrier, in particular to control the acquisition of the measurements, the storage of measurement data and any derived data and, if applicable, the sending of data to a computer system using a transmission unit. The control unit usually comprises a processor, a program memory and a main memory.

goods carrier also comprises a position sensor.

A “sensor” is in general a technical component which can detect certain physical or chemical properties and/or the material composition of its environment in a qualitative manner, or in a quantitative manner as a measurement variable. The properties are detected by means of physical or chemical effects and transformed into (usually electrical) signals for further processing.

The position sensor may be configured to detect a change in the position of the goods carrier. In some embodiments, the position sensor may be configured to detect whether a lower end of the goods carrier is in contact with a support. If a lower end of the goods carrier is not in contact with a support, it is either raised or not properly positioned (for example, it may have turned over).

In some embodiments, the position sensor can be a switch on a lower end of the goods carrier, wherein for a goods carrier positioned at a location the lower end is in contact with a support (the floor or a table or shelf or the like, on which the goods carrier is placed).

The switch may be configured such that it can have two states: a first state when the goods carrier is properly positioned (a lower end of the goods carrier in contact with a support), and a second state when the goods carrier is raised or the lower end is no longer in contact with the support.

In some embodiments, the goods carrier according to the present disclosure comprises an acceleration sensor. An acceleration sensor is a sensor that measures an acceleration. This is usually achieved by determining the inertial force acting on a test mass. Thus, it can be determined, for example, whether an increase or decrease in speed is taking place. An example of an acceleration sensor is a piezoelectric acceleration sensor, in which a small piezoceramic sensor plate converts dynamic pressure fluctuations into electrical signals. The pressure fluctuation is generated by a (seismic) mass attached to the piezoceramic which acts on the piezoelectric ceramic when the entire system undergoes an acceleration. Another example of an acceleration sensor is a micro-electromechanical system (MEMS), which is usually produced from silicon by an etching process. These sensors are spring-mass systems, in which the “springs” are silicon beams a few microns wide. The mass may also be made of silicon. By means of the deflection under acceleration, a change in the electrical capacitance between the elastically suspended part and a fixed reference electrode can be measured. The electronics for evaluating the capacitance change are usually accommodated on the same integrated circuit (IC).

If the goods carrier is accelerated in a direction opposite to (at least a component of) the inertial force acting on the test mass, this acceleration is detected by the acceleration sensor.

Preferably, the goods carrier comprises a triaxial acceleration sensor, which can be used to detect accelerations in all three spatial directions.

In some embodiments, the goods carrier may also be equipped with a gyroscope sensor or a rotation rate sensor to detect rotations of the goods carrier. Preferably, the goods carrier is equipped with a triaxial gyroscope sensor or a triaxial rotation rate sensor.

In some embodiments, an acceleration sensor, preferably in combination with a gyroscope sensor or rotation rate sensor, can therefore be used to detect movements and rotations of the goods carrier in all three spatial directions.

In some embodiments, the goods carrier can also be equipped with a magnetometer to measure the Earth's magnetic field. Such a sensor can contribute to determining the absolute orientation or to determining an absolute change of orientation of the goods carrier.

A sensor comprising at least one acceleration sensor and/or at least one gyroscope or rotation rate sensor and optionally a magnetometer, is also referred to in this description as a motion sensor. In some embodiments, the motion sensor may comprise a triaxial acceleration sensor. In some embodiments, the motion sensor may comprise a triaxial acceleration sensor and a triaxial gyroscope or rotation rate sensor.

The goods carrier preferably comprises at least one inventory sensor.

The inventory sensor is configured to record measured values from which the inventory of product units in the goods carrier, or in a goods holder of the goods carrier, can be determined. “Inventory” preferably refers to the number of product units in the goods carrier or goods holder. “Inventory” can also mean the (binary) information as to whether the goods carrier or a goods holder of the goods carrier is empty or whether at least one product unit is still present. “Inventory” can also mean the (ternary) information as to whether the goods carrier or a goods holder of the goods carrier is empty, whether the goods carrier or a goods holder of the goods carrier is completely filled, or whether the goods carrier or a goods holder of the goods carrier is partially filled. Other definitions for the term “inventory” are conceivable.

It is conceivable that a goods carrier may comprise a plurality of inventory sensors, particularly if the goods carrier comprises a plurality of goods holders; in this case, each goods holder may comprise an inventory sensor which records the inventory in the respective goods holder.

The inventory sensor can be an inventory sensor as described in the prior art (see e.g. EP3136320A1, WO2019014742A1, US20050168345A1).

In some embodiments, the inventory sensor may be a light sensor which is positioned such that it is hidden when a product unit is located in the goods carrier or in a goods holder of the goods carrier, and is not hidden if there is no product unit in the goods carrier or in a goods holder of the goods carrier.

A light sensor is a sensor that directly or indirectly measures the intensity of electromagnetic radiation in a defined wavelength range. In some embodiments, the wavelength range is preferably in the range from 300 nm to 3 μm.

In some embodiments, the light sensor (also known as a photodetector, optical detector or optoelectronic sensor) may convert light into an electrical signal using the photoelectric effect; in some embodiments, the light sensor may have an electrical resistance dependent on the incident radiation.

In some embodiments, a preferred light sensor is a photodiode. A photodiode is a semiconductor diode that converts light in the visible, IR, or UV range at a p-n junction or pin junction into an electrical current using the internal photoelectric effect or—depending on the circuitry—provides the sensor with an illumination-dependent resistance. It is used, among other functions, to convert light into an electrical voltage or an electric current, or to receive information transmitted with light.

In some embodiments, the light sensor may be covered by one or more product units located in the goods carrier. In this state, little or no light is incident on the light sensor. If all product units are removed from the goods carrier, the light sensor is no longer covered; (more) light can then fall on the sensor. The light may be sunlight, artificial light in a sales room, or light from a light source which is part of the goods carrier according to the invention, and which is positioned in such a way that with a (partially) filled goods carrier one or more product units are located between the light source and the light sensor, whereas with an empty goods carrier (without product units) the radiation emitted by the light source strikes the light sensor unimpeded. The light source can be, for example, an LED or a laser diode. A number of other light sources are also conceivable.

If the inventory sensor is designed as a light sensor and the light sensor receives daylight or artificial light from the sales room in which the goods carrier is positioned, misinterpretations can occur when night falls and/or the artificial light is switched off. An empty goods carrier could be interpreted as an (at least partially) filled goods carrier when no light strikes the light sensor due to a lack of light. The control unit of the goods carrier can be configured to receive or evaluate measured values from the light sensor only during defined time intervals during which customer traffic can be expected. Defined time intervals can be, for example, from the opening of the respective store in the morning (e.g. at 7 a.m. or at 8 a.m. or 9 a.m.) until the closing of the respective store in the evening (e.g. at 6 p.m. or at 7 p.m. or at 8 p.m.). Depending on store opening times, the control unit can be configured not to carry out sensor queries or interpretation of measured values on Sundays and public holidays and, if applicable, Saturdays.

In some embodiments, the goods carrier according to the present disclosure may comprise a timer. Time intervals can be determined using the timer.

In some embodiments, the control unit is configured to use a timer and an inventory sensor to measure the time interval during which there are no product units in the goods carrier (i.e. the goods carrier is empty).

In some embodiments, the control unit is configured to use a timer and a position sensor to measure the time interval during which a lower end of the goods carrier makes no contact with a support (i.e., the goods carrier is raised or is not properly positioned).

In some embodiments, the control unit is configured to use a timer and an acceleration sensor to measure the time interval during which the goods carrier is subjected to an acceleration. Preferably, the direction of the acceleration is also determined.

In some embodiments, the control unit is configured such that it uses a motion sensor and/or a timer to determine a distance between a first location and a second location, wherein the goods carrier has been moved from the first location to the second location. It is possible to configure the control unit to determine, based on the motion sensor, the number of steps taken by a person who moves the goods carrier from the first to the second location (step counter). If a mean step length that a person performs is defined (for example, 1 gradus=2½ pedes (slightly more than 74 cm)), a distance can be calculated from the product of the number of steps and the mean step length. It is also conceivable to first determine the time interval in which the goods carrier performs a movement and to then multiply this time interval by an average speed (for example, a mean walking pace of a person of 1 meters per second) in order to determine a distance.

In some embodiments, the goods carrier may also comprise a data store. The data store is used for storing data. The data store is preferably designed to be machine-readable and machine-writable. The data store is particularly preferably implemented as a non-volatile data store, so that in case of a power interruption, loss of data can be avoided. The data store is preferably a semiconductor memory.

The control unit can be configured to store measured values, received from the sensors, in the data store. The control unit can be configured to perform calculations based on the measured values and to store the results of the calculations in the data store. In some embodiments, the control unit is configured to read out readings and/or results of calculations stored in the data memory.

In some embodiments, the goods carrier according to the present disclosure may comprise a transmitter unit. The control unit of the goods carrier may be configured to cause the transmitter unit to transfer data (e.g. measured values and/or results of calculations stored in the data memory) to a computer system via a network. The data can be transferred by wires and/or wirelessly (for example by radio). For example, the goods carrier can be equipped with a mobile radio transmitter. With the aid of the mobile radio transmitter, the goods carrier transfers at least a proportion of the data to a computer system via a mobile radio network (e.g. based on the GSM, GPRS, UMTS, 2G, 3G, LTE, 4G or 5G standard). It is also possible for the transmitter unit to transmit data via Bluetooth, WLAN, DECT, Zigbee or another short-range radio connection to a base station within range of the transmitter unit, from where it is forwarded (possibly via further network connections) to the computer system.

The transferred data is usually analyzed and evaluated on the computer system.

A “computer system” is a system for electronic data processing that processes data by means of programmable computation rules. Such a system usually comprises a “computer”, the unit that comprises a processor for carrying out logical operations, as well as a peripheral.

In computer technology, “peripherals” refer to all devices that are connected to the computer and are used for control of the computer and/or as input and output devices. Examples thereof are monitor (screen), printer, scanner, mouse, keyboard, drives, camera, microphone, speakers, etc. Internal ports and expansion cards are also regarded as peripherals in computer technology.

Today's computer systems are commonly subdivided into desktop PCs, portable PCs, laptops, notebooks, netbooks and tablet PCs, and so-called handhelds (e.g. smartphones); all such systems can be used for execution of the invention.

Inputs into the computer system are made via input devices, for example a keyboard, a mouse, a microphone, and/or the like. “Input” is also to be understood as meaning the selection of an entry from a virtual menu or from a virtual list or clicking on a checkbox and the like.

The outputs of the computer system are usually provided via a screen, a printer or by storage in a data store.

The computer system can be used to manage the data of a plurality of goods carriers. It is conceivable that a plurality of computer systems exist, which are distributed e.g. over different countries and/or geographical regions.

The measured values collected by the sensors can be analyzed and evaluated in a variety of ways to obtain information about the status of the goods carrier. Processes of data processing, analysis, and evaluation can be carried out by the sensors themselves (or by microprocessors and integrated circuits, which may be components of the sensors), by the control unit of the goods carrier according to the invention or by the computer system.

For the present invention, it does not matter where the data is processed, analyzed and evaluated. It is conceivable for the sensors to transfer raw measurement data, which is interpreted, evaluated and analyzed by the computer system. It is conceivable for the complete interpretation of the measured values to be carried out by the sensors themselves and/or the transmitter unit of the goods carrier and for the information transferred to the computer system to be only displayed to a user there. All conceivable possibilities between the two cases mentioned should also be covered by the invention. Therefore, in the following it is not specified in detail at which point of which unit which calculations are carried out, but rather the invention is described in more detail on the basis of method variants, wherein individual steps of the method can be executed by a sensor, the control unit of the goods carrier, or the computer system.

The present disclosure further provides a method for monitoring a goods carrier, wherein the method comprises the following steps:
recording an inventory of product units in the goods carrier,
determining a time interval during which there are no product units present in the goods carrier, and
displaying the time interval to a person.

This allows the system to monitor how long it takes for an empty goods carrier to be filled with product units. The longer it takes for the goods carrier to be refilled, the longer the goods carrier is not fulfilling its purpose, since, although customers may become aware of a (new) product, they cannot purchase it.

The present disclosure further provides a method for monitoring a goods carrier, wherein the method comprises the following steps:
recording an inventory of product units in the goods carrier,
determining a time interval during which there are no product units present in the goods carrier,
comparing the time interval with a predefined threshold value, and
in the event that the time interval exceeds the predefined threshold value: sending a notification to a person that the threshold value has been exceeded.

Short time intervals (such as 1 to 30 minutes) in which no product units are present in the product carrier may be tolerated. However, if the time interval in which no product is displayed exceeds a predefined threshold value (e.g. 30 minutes or 60 minutes or the like), additional measures may be required. A notification may inform a person that the goods carrier has been unfilled for a considerable period of time and the person may take actions, such as commissioning a filling operation or performing it him/herself.

The present disclosure further provides a method for monitoring a goods carrier, wherein the method comprises the following steps:
detecting a position of the goods carrier, and
in the event that one end of the goods carrier does not make contact with a support: sending a notification to a person.

If the goods carrier is not properly positioned, a person will be notified of it. The person can then visit the goods carrier (or have it visited) and position it (have it positioned) properly.

The present disclosure further provides a method for monitoring a goods carrier, wherein the method comprises the following steps:
detecting a position of the goods carrier,
determining a time interval during which one end of the goods carrier does not make contact with a support, and
displaying the time interval to a person.

The time intervals during which the goods carrier is not properly positioned are recorded. The longer the individual time intervals and/or the sum of the individual time intervals, the less the goods carrier is able to perform its intended function.

The present disclosure further provides a method for monitoring a goods carrier, wherein the method comprises the following steps:
detecting a position of the goods carrier,
determining a time interval during which one end of the goods carrier does not make contact with a support,
comparing the time interval with a predefined threshold value, and
in the event that the time interval exceeds the predefined threshold value: sending a notification to a person that the threshold value has been exceeded.

It is possible that the goods carrier is raised for only a short period of time (e.g. 1 second to 30 seconds), for example to clean the support and/or the goods carrier. Such an interruption of the proper positioning is not problematic and can be ignored. However, if a pre-defined threshold of a time interval is exceeded, measures may be necessary to ensure that the goods carrier is properly positioned. It is also conceivable that the goods carrier may have been moved from a first location to a second; the longer the period of time during which the goods carrier is not properly positioned at the first location, the greater may be the distance from the second location at which it is re-positioned.

The present disclosure further provides a method for monitoring a goods carrier, wherein the method comprises the following steps:
detecting a position of the goods carrier, and
in the event that one end of the goods carrier does not make contact with a support:
   determining a movement of the goods carrier,
   in the event that the goods carrier is performing a horizontal movement:
   determining a distance travelled by the goods carrier during the horizontal movement, and
   displaying the distance to a person.

A horizontal movement should be understood to mean a movement for which at least a component is in a horizontal direction. For example, if a goods carrier is lifted up from a table and then placed on the floor next to the table, the goods carrier first performs a vertical movement (lifting up from the table (upwards)) and then a combined vertical and horizontal movement (placing on the floor next to the table) that comprises vertical (depositing, i.e. there is a component in the vertical direction (downwards)) and horizontal (sideways movement from the table to a position next to the table) components.

In the above-mentioned method, it is first determined whether the goods carrier is correctly positioned. If it is lifted, one end of the goods carrier is no longer in contact with the support. It is conceivable for the goods carrier to be moved horizontally and thus removed from the original location. During the period of time in which the goods carrier is no longer in contact with the support, measured values from at least one movement sensor are recorded and/or evaluated in order to determine a distance traveled by the goods carrier in the horizontal direction. This distance is displayed to a person so that the person knows that the goods carrier is no longer in the original location and so that this person knows the distance from the original location at which the goods carrier has been placed.

The present disclosure further provides a method for monitoring a goods carrier, wherein the method comprises the following steps:
detecting a position of the goods carrier, and
in the event that one end of the goods carrier does not make contact with a support:
   determining a movement of the goods carrier,
   in the event that the goods carrier is performing a horizontal movement:
   determining a distance that the goods carrier travels during the horizontal movement,
   comparing the distance to a predefined threshold value, and
   in the event that the distance exceeds the predefined threshold value: sending a notification to a person that the threshold value has been exceeded.

It is conceivable that slight horizontal displacements of the goods carrier can be tolerated (e.g. 1 cm to 5 meters). However, if the distance from the original location exceeds a pre-defined threshold value, the placement of the goods and, if applicable, the presentation of the goods may have changed in such a way that they no longer correspond to the placement of the goods and, if appropriate, the presentation of the goods intended for the goods carrier. A person is informed about this situation in order to be able to remedy the situation where possible (e.g. by returning the goods carrier to its original location).

The present disclosure further provides a method for monitoring a goods carrier, wherein the method comprises the following steps:
detecting a movement of the goods carrier,
determining a distance travelled by the goods carrier during the movement, and
displaying the distance to a person.

If the goods carrier is moved, the distance it travels in the process is determined and this distance is indicated to a person so that the person is informed where the goods carrier is located.

The present disclosure further provides a method for monitoring a goods carrier, wherein the method comprises the following steps:
detecting a movement of the goods carrier,
determining a distance travelled by the goods carrier during the movement,
comparing the distance to a predefined threshold value, and
in the event that the distance exceeds the predefined threshold value: sending a notification to a person that the threshold value has been exceeded.

In order to initiate measures as appropriate (e.g. by returning the goods carrier to its original location), a person will only be informed if the goods carrier has been positioned at a location further away from the original location than a pre-defined threshold value specifies.

It would be desirable if an existing goods carrier could be equipped with the functionalities of the goods carrier according to the invention without modification of the goods carrier. This is possible by using a monitoring unit which is equipped with the functionalities of the goods carrier according to the invention (with the exception of the functionality of the goods holder) and which can be connected to a goods carrier in a reversible manner

The present disclosure further relates to a monitoring unit comprising
means for connecting the monitoring unit to a goods carrier for the presentation of product units,
a control unit,
a data store, and
a position sensor,
   wherein the position sensor is configured to record measured values relating to a position of the goods carrier when the monitoring unit is connected to the goods carrier, and wherein the control unit is configured to receive the measured values from the position sensor and store them in the data store.

Preferably, the monitoring unit is designed in such a way that it can be connected to the goods carrier in a reversible manner

The means for connecting the monitoring unit to a goods carrier can be an adhesive connection, a screw connection, a clamped connection, a Velcro connection and/or the like.

In some embodiments, the monitoring unit comprises a transmitter unit, wherein the control unit is configured to cause the transmitter unit to transfer data to a computer system over a network.

In some embodiments, the monitoring unit comprises at least one acceleration sensor, preferably a triaxial acceleration sensor.

In some embodiments, the monitoring unit comprises at least one gyroscope sensor or a rotation rate sensor, preferably a triaxial gyroscope sensor or a triaxial rotation rate sensor.

In some embodiments, the monitoring unit comprises at least one motion sensor comprising
at least one acceleration sensor, preferably a triaxial acceleration sensor, and/or
at least one gyroscope sensor or a rotation rate sensor, preferably a triaxial gyroscope sensor or a triaxial rotation rate sensor,
   and optionally a magnetometer.

In some embodiments, the monitoring unit comprises an inventory sensor that records an inventory of product units in the goods carrier.

In some embodiments, the monitoring unit comprises a housing for receiving the control unit, the data memory, the inventory sensor, the motion sensor, if present, the magnetometer, if present, and the transmitter unit, if present, wherein the monitoring unit is configured in such a way that it can preferably be placed underneath a lowest product unit in the goods carrier, wherein a position sensor is preferably connected to the control unit via a cable and the position sensor is preferably configured in such a way that it is placed outside the housing of the monitoring unit at one end of the goods carrier (for example, by means of an adhesive connection, a screw connection, a clamped connection, a Velcro connection and/or the like).

The monitoring unit according to the present disclosure can be equipped with (as can the goods carrier according to the present disclosure) a power supply unit (for example, an electrochemical cell (battery) or a rechargeable battery). It is also conceivable for the monitoring unit and/or the goods carrier to be connected to a power supply on the sales floor.

The present disclosure further provides a system comprising
at least one goods carrier according to the invention or at least one monitoring unit according to the invention, and
a computer system.

The computer system can be configured to receive data from the storage unit of the goods carrier or the monitoring unit, to store it in a data store, and/or display it to a person.

The computer system can be configured to receive data from the storage unit of the goods carrier or the monitoring unit, calculate time intervals and/or distances, and display the calculated time intervals and/or distances to a person.

The computer system may be configured to receive data from the storage unit of the goods carrier or the monitoring unit, and/or to receive time intervals and/or distances from the storage unit of the goods carrier or the monitoring unit, and/or to calculate and receive time intervals and/or distances and/or compare the calculated time intervals and/or distances with one or more predefined threshold values, and if a predefined threshold value is exceeded to send a notification to a person that the predefined threshold value has been exceeded.

Further embodiments of the present disclosure include:

A. A monitoring unit comprising
means for connecting the monitoring unit to a goods carrier for the presentation of product units,
a control unit,
a data store, and
a position sensor,
   wherein the position sensor is configured to record measured values relating to a position of the goods carrier when the monitoring unit is connected to the goods carrier, and wherein the control unit is configured to receive the measured values from the position sensor and store them in the data store.
   B. The monitoring unit according to embodiment A, also comprising a motion sensor, wherein the motion sensor comprises at least one acceleration sensor, preferably a triaxial acceleration sensor and/or a gyroscope sensor or a rotation rate sensor, preferably a triaxial gyroscope sensor or a triaxial rotation rate sensor, wherein the control unit is configured to receive the measured values from the motion sensor and store them in the data memory.
   C. The monitoring unit according to either of the embodiments A or B, further comprising an inventory sensor, wherein the inventory sensor records an inventory of product units in the goods carrier, the control unit being configured to receive the measured values from the inventory sensor and store them in the data memory.
   D. The monitoring unit according to any one of the embodiments A, B or C, also comprising a timer.
   E. The monitoring unit as claimed in any one of the embodiments A, B, C or D, further comprising a transmitter unit, the control unit being configured to cause the transmitter unit to transfer data to a computer system, wherein the data consists of
measured values of the position sensor, the motion sensor, the inventory sensor and/or the timer and/or
results of calculations by the control unit based on the measured values of the position sensor, the motion sensor, the inventory sensor and/or the timer.
   F. The monitoring unit according to any one of the embodiments A, B, D or E, further comprising a housing, wherein the control unit, the data memory, and, if present, a power supply unit, the transmitter unit and the motion sensor are located in the housing, the housing being designed in such a way that it can be placed underneath a lowermost product unit in the goods carrier, wherein the inventory sensor records measured values relating to the lowermost product unit located above the housing.
   G. The monitoring unit according to embodiment F, wherein the position sensor is a switch and is preferably connected to the control unit via a cable and configured in such a way as to be placed at one end of the goods carrier.
   H. The monitoring unit according to any one of the embodiments A, B, D, E, F or G, wherein the inventory sensor is a light sensor or comprises a light sensor.
   I. The monitoring unit according to any one of the embodiments A, B, D, E, F, G or H, wherein the control unit is configured to use a timer and an inventory sensor to measure a time interval during which there are no product units in the goods carrier.
   J. The monitoring unit according to any one of the embodiments A, B, D, E, F, G, H, or I, wherein the control unit is configured to use a timer and a position sensor to measure a time interval during which a lower end of the goods carrier has no contact with a support.
   K. The monitoring unit according to any one of the embodiments A, B, D, E, F, G, H, I or J, wherein the control unit is configured to use a timer and an acceleration sensor to measure a time interval during which the goods carrier is subjected to an acceleration.
   L. The monitoring unit according to any one of the embodiments A, B, D, E, F, G, H, I, J or K, wherein the control unit is configured to use a motion sensor and/or a timer to measure a distance between a first location and a second location if the goods carrier is/has been moved from the first location to the second location.
   M. A goods carrier for the presentation of product units, comprising
a goods holder for holding a plurality of product units,
a control unit,
a data store, and
a position sensor,
   wherein the position sensor is configured to record measured values relating to a position of the goods carrier, and wherein the control unit is configured to receive the measured values from the position sensor and store them in the data store.
   N. The goods carrier according to embodiment M, comprising a goods holder for holding a plurality of product units and a monitoring unit according to any one of claims 1 to 12.
   O. The goods carrier according to either of the embodiments M or N, wherein the inventory sensor is a light sensor or comprises a light sensor, the light sensor being positioned so that it is concealed when a product unit is located in the goods holder and is not covered when there is no product unit in the goods holder.
   P. A method for monitoring a goods carrier, wherein the method comprises the following steps:
connecting a goods carrier to a monitoring unit according to any one of the embodiments A to L,
detecting a position of the goods carrier by means of the monitoring unit, and
in the event that one end of the goods carrier does not make contact with a support: sending a notification to a person by means of the monitoring unit.
   Q. The method according to embodiment P, comprising the steps of:
determining a time interval during which one end of the goods carrier does not make contact with a support, by means of the monitoring unit, and
notifying a person of the time interval by means of the monitoring unit.
   R. The method according to either of the embodiments P or Q, comprising the steps of:
detecting a position of the goods carrier by means of the monitoring unit,
determining a time interval during which one end of the goods carrier does not make contact with a support, by means of the monitoring unit,
comparing the time interval with a predefined threshold value by means of the monitoring unit, and
in the event that the time interval exceeds the predefined threshold value: sending a notification to a person that the threshold value has been exceeded, by means of the monitoring unit.
   S. The method according to any one of the embodiments P, Q or R, comprising the steps of:
detecting a position of the goods carrier by means of the monitoring unit, and
in the event that one end of the goods carrier does not make contact with a support:
   determining a movement of the goods carrier by means of the monitoring unit, and
   in the event that the goods carrier is performing a horizontal movement:
      determining a distance traveled by the goods carrier during the horizontal movement, by means of the monitoring unit, and
      displaying the distance to a person.
         T. The method according to any one of the embodiments P, Q, R or S, comprising the steps of:
detecting a position of the goods carrier by means of the monitoring unit, and
in the event that one end of the goods carrier does not make contact with a support:
   determining a movement of the goods carrier by means of the monitoring unit, and
   in the event that the goods carrier is performing a horizontal movement:
      determining a distance traveled by the goods carrier during the horizontal movement, by means of the monitoring unit,
      comparing the distance with a predefined threshold value by means of the monitoring unit, and
      in the event that the distance exceeds the predefined threshold value:

sending a notification to a person that the threshold value has been exceeded, by means of the monitoring unit.

U. The method according to any one of the embodiments P, Q, R, S or T, comprising the steps of:
detecting a movement of the goods carrier by means of the monitoring unit,
determining a distance travelled by the goods carrier during the movement, by means of the monitoring unit, and
displaying the distance to a person.
   V. The method according to any one of the embodiments P, Q, R, S, T or U, comprising the steps of:
detecting a movement of the goods carrier by means of the monitoring unit,
determining a distance travelled by the goods carrier during the movement, by means of the monitoring unit,
comparing the distance with a predefined threshold value by means of the monitoring unit, and
in the event that the distance exceeds the predefined threshold value: sending a notification to a person that the threshold value has been exceeded, by means of the monitoring unit.
   W. The method according to any one of the embodiments P, Q, R, S, T, U or V, comprising the steps of:
recording an inventory of product units in the goods carrier by means of the monitoring unit,
determining a time interval during which there are no product units present in the goods carrier, by means of the monitoring unit, and
displaying the time interval to a person.
   X. The method according to any one of the embodiments P, Q, R, S, T, U, V or W, comprising the steps of:
recording an inventory of product units in the goods carrier by means of the monitoring unit,
determining a time interval during which there are no product units present in the goods carrier, by means of the monitoring unit,
comparing the time interval with a predefined threshold value by means of the monitoring unit, and
in the event that the time interval exceeds the predefined threshold value: sending a notification to a person that the threshold value has been exceeded, by means of the monitoring unit.
   Y. A system comprising
at least one monitoring unit according to any one of the embodiments A to L and optionally a goods carrier with a goods holder for holding a plurality of product units,
   or at least one goods carrier according to any one of the embodiments M, N or 0, and
a computer system,
   wherein the monitoring unit and the computer system are connected together via a network or the goods carrier and the computer system are connected together via a network.

1. A monitor comprising
controller,
a data store, and
a position sensor,
wherein the monitor is configured to connect to a goods carrier for the presentation of product units;
wherein the position sensor is configured to record measured values relating to a position of the goods carrier when the monitor is connected to the goods carrier; and
wherein the controller is configured to receive the measured values from the position sensor and store them in the data store.

2. The monitor of claim 1, further comprising a motion sensor, wherein the motion sensor comprises at least one acceleration sensor, preferably a triaxial acceleration sensor and/or a gyroscope sensor or a rotation rate sensor, preferably a triaxial gyroscope sensor or a triaxial rotation rate sensor, and wherein the controller is configured to receive the measured values from the motion sensor and store them in the data store.

3. The monitor of claim 1, further comprising an inventory sensor, wherein the inventory sensor records an inventory of product units in the goods carrier and wherein the controller is configured to receive the measured values from the inventory sensor and store them in the data store.

4. The monitor of claim 1, further comprising a timer.

5. The monitor of claim 1, further comprising a transmitter unit, wherein the controller is configured to cause the transmitter unit to transfer data to a computer system, wherein the data consists of
measured values of the position sensor, the motion sensor, the inventory sensor and/or the timer, and/or
results of calculations by the controller based on the measured values of the position sensor, the motion sensor, the inventory sensor, and/or the timer.

6. The monitor of claim 3, further comprising a housing configured to contain the controller, the data store, the transmitter unit, the motion sensor and, if present, a power supply, wherein the housing is configured to be placed underneath a lowermost product unit in the goods carrier, and wherein the inventory sensor records measured values relating to the lowermost product unit located above the housing.

7. The monitor of claim 6, wherein the position sensor is a switch, is preferably connected to the controller via a cable, and is configured to be placed at one end of the goods carrier.

8. The monitor of claim 1, wherein the inventory sensor is a light sensor or comprises a light sensor.

9. The monitor of claim 1, wherein the controller is configured to use a timer and an inventory sensor to measure a period of time during which there are no product units in the goods carrier.

10. The monitor of claim 1, wherein the controller is configured to use a timer and a position sensor to measure a period of time during which a lower end of the goods carrier has no contact with a support.

11. The monitor of claim 1, wherein the controller is configured to use a timer and an acceleration sensor to measure a period of time during which the goods carrier is subjected to an acceleration.

12. The monitor of claim 1, wherein the controller is configured to use a motion sensor and/or a timer to measure a distance between a first location and a second location when the goods carrier is/has been moved from the first location to the second location.

13. A goods carrier for presenting product units, comprising
a goods holder device for holding a plurality of product units,
a controller,
a data store, and
a position sensor,
wherein the position sensor is configured to record measured values relating to a position of the goods carrier, and
wherein the controller is configured to receive the measured values from the position sensor and store them in the data store.

14. The monitor of claim 1, wherein the goods carrier for presenting product units comprises
a goods holder device for holding a plurality of product units,
a data store,
a position sensor configured to record measured values relating to a position of the goods carrier, and
a controller configured to receive the measured values from the position sensor and store them in the data store.

15. A method for monitoring a goods carrier, the method comprising:
connecting a goods carrier to a monitor, wherein the monitor comprises
a data store,
a position sensor configured to record measured values relating to a position of the goods carrier when the monitor is connected to the goods carrier,
and a controller configured to receive the measured values from the position sensor and store them in the data store;
detecting, with the monitor, a position of the goods carrier, and
in the event that one end of the goods carrier does not make contact with a support: sending, with the monitor, a notification to a person.

16. A system comprising:
at least one monitor and optionally a goods carrier with a goods holder for holding a plurality of product units, wherein the monitor is configured to connect to the goods carrier and wherein the monitor comprises
a data store,
a position sensor configured to record measured values relating to a position of the goods carrier when the monitor is connected to the goods carrier,
and a controller configured to receive the measured values from the position sensor and store them in the data store;
or at least one goods carrier, wherein the at least one goods carrier comprises
a goods holder device for holding a plurality of product units,
a data store,
a position sensor configured to record measured values relating to a position of the goods carrier, and
a controller configured to receive the measured values from the position sensor and store them in the data store;
and
a computer system,
wherein the monitor and the computer system are connected together via a network or the goods carrier and the computer system are connected together via a network.
